(19) United States
(12) Patent Application Publication
(10) Pub. No.: US 2010/0241486 A1
(43) Pub. Date: Sep. 23, 2010

(54) REDUCING REVENUE RISK IN ADVERTISEMENT ALLOCATION

(75) Inventors: Sachin Garg, Bangalore (IN); Krishna Prasad Chitrapura, Bangalore (IN)

Correspondence Address: FIALA & WEAVER, P.L.L.C.;C/O CPA GLOBAL, P.O. BOX 52050, MINNEAPOLIS, MN, 55402, US

(73) Assignee: Yahoo! Inc., Sunnyvale, CA (US)

(21) Appl. No.: 12/406,469

(22) Filed: Mar. 18, 2009

(51) Int. Cl. G06Q 30/00; G06Q 10/00; G06N 5/02

(52) U.S. Cl. 705/10; 705/26; 706/52; 705/14.71

(57) ABSTRACT

Methods, systems, and apparatuses are provided for selecting advertisements in an advertisement auction. A plurality of bids for an advertisement placement is received. An average expected payout for each bid of the plurality of bids is calculated to determine a plurality of average expected payouts. A plurality of possible allocations of the advertisements is determined. An expected revenue value for each of the possible allocations is calculated based on the calculated average expected payouts to generate a plurality of expected revenue values. A risk value is calculated for each of the possible allocations to generate a plurality of risk values. A bid of the plurality of bids is enabled to be selected based on the calculated expected revenue values and risk values.

### BACKGROUND OF THE INVENTION

1. Field of the Invention

The present invention relates to the allocation of advertisements online.

2. Background Art

Online advertisement (“ad”) networks enable online ads to be served to users visiting the websites of publishers that are participating in the online ad network. For example, a user may use an electronic device to access a particular web page that includes locations for advertisements to be displayed. In another example, the user may use the electronic device to access a website to perform a search (e.g., using a search engine) that returns a search results page having location for advertisements to be displayed.

Advertisement auctions have been created that enable advertisers to bid to have their ads displayed on websites. Multiple advertisers may bid to have one of their advertisements displayed in any particular advertisement location present in a web page. According to one technique, a winning bidder for a particular advertisement location may be calculated by multiplying a bid amount by a probability of conversion (an action resulting in payment by the bidder) to determine a cost per impression (e.g., CPM—cost per thousand impressions) for each bidder, and awarding the advertisement location to the bidder having the highest calculated CPM. Such a calculation is intended to optimize expected revenue for the auction.

For example, in one instance, three advertisers may bid for a particular advertisement location. The first bidder may submit a bid of $103, and may have a conversion probability of 0.01, for a calculated CPM of $1.03. The second bidder may submit a bid of $51, and may have a conversion probability of 0.02, for a calculated CPM of $1.02. The third bidder may submit a bid of $1, and may have a conversion probability of 1, for a calculated CPM of $1. If revenue for the auction is determined in the manner described above, the first bidder would win the bidding because the CPM of $1.03 is greater than the other CPMs of $1.02 and $1.

This technique for determining expected revenue may be both risky and unfair. For instance, this technique may be risky because due to the conversion probability of 0.01, for every 100 times the advertisement is displayed, a relatively large payoff of $103 is expected once, while nothing ($0) is expected the remaining 99 times. This technique may be unfair because, although the calculated CPMs for the losing bids were very close in value to the CPM for the winning bid, those bidders do not receive the opportunity to have an advertisement displayed. In an auction setting, the losing bidders do not know how much they need to increase their bids to become competitive because the information regarding the CPM calculations is hidden to them.

Thus, revenue determination techniques for online advertisement auctions that are less risky and more fair are desired.

### BRIEF SUMMARY OF THE INVENTION

Methods, systems, and apparatuses are provided for expected revenue determination and risk determination with regard to online advertisement auctions. Expected revenue values and risk values are enabled to be determined for various possible allocations of advertisements. The expected revenue values and risk values enable advertisements to be selected for display in an advertisement auction in a fairer and/or less risky manner.

In one implementation, a method is provided for selecting advertisements in an advertisement auction. A plurality of bids for an advertisement placement is received. An average expected payout for each bid of the plurality of bids is calculated to determine a plurality of average expected payouts. A plurality of possible allocations of the advertisements is determined. An expected revenue value for each of the possible allocations is calculated based on the calculated average expected payouts to generate a plurality of expected revenue values. A risk value is calculated for each of the possible allocations to generate a plurality of risk values. A bid of the plurality of bids is enabled to be selected based on the calculated expected revenue values and risk values.

The expected revenue value for each of the plurality of possible allocations may be calculated according to

ER(z)=X_{z}^{T}M,

where
X_{z}=a vector indicating a possible allocation z of advertisements of the plurality of possible allocations,
M=a vector containing the calculated average expected payout for each bid of the plurality of bids, and
ER(z)=the expected revenue value calculated for possible allocation z; and
   The risk value for each of the plurality of possible allocations may be calculated by calculating a variance for each calculated average expected payout, and calculating the risk value corresponding to each calculated expected revenue value according to

Risk(a)=X_{z}ΣX_{Z}^{T},

where

Σ=a covariance matrix containing the calculated variance for each calculated average expected payout, and

Risk(z)=the risk value calculated for possible allocation z.

Furthermore, the variance for each calculated average expected payout may be calculated according to

σᵢ=(1−PR(cᵢ))(eCPMᵢ)²,

where

PR(cᵢ)=a probability of conversion corresponding to bid i;

eCPMᵢ=the calculated average expected payout corresponding to bid i; and

σᵢ=the calculated variance corresponding to bid i.

Still further, a covariance may be calculated for each combination of advertisements associated with the plurality of bids according to

$${σ}_{i , j} = {\sum }_{n ∈ {P}_{Tree}} PR ( n \vert i , j ) ( \begin{matrix}( 1 - PR ( {c}_{i} \vert n ) ) \\ ( PR ( {c}_{i} \vert n ) {b}_{i} )\end{matrix} ) ( \begin{matrix}( 1 - PR ( {c}_{j} \vert n ) ) \\ ( PR ( {c}_{j} \vert n ) {b}_{j} )\end{matrix} )$$

where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σ_{i,j}=the calculated covariance corresponding to bids i and j;
   The covariance matrix contains the calculated covariance for each combination of bids of the plurality of bids. A set of impressions may be divided into subsets of impressions based on the attributes of the impressions of the set to create subsets of impressions as mentioned above. These subsets may be overlapping, non-overlapping (partitions), and/or hierarchical.

Alternatively, the covariance may be calculated for each combination of advertisements associated with the plurality of bids according to

σᵢⱼₙ=((1−PR(cᵢ|n))(PR(cᵢn)bᵢ))((1−PR(cⱼ|n))(PR(cⱼ|n)bⱼ)).

In another implementation, an advertisement serving system is provided. The advertisement serving system includes an expected payout calculator, an expected revenue calculator, a risk calculator, and a bid selector module. The expected payout calculator is configured to calculate an average expected payout for each bid of a plurality of bids for an advertisement placement to determine a plurality of average expected payouts. The expected revenue calculator is configured to calculate an expected revenue value for each of a plurality of possible allocations of advertisements corresponding to the plurality of bids based on the plurality of average expected payouts to generate a plurality of expected revenue values. The risk calculator is configured to calculate a risk value for each of the plurality of possible allocations to generate a plurality of risk values. The bid selector module configured to enable a bid of the plurality of bids to be selected based on the expected revenue values and risk values.

Computer program products are also described herein. The computer program products include a computer-readable medium having computer program logic recorded thereon for enabling risk values and expected revenue values to be generated for various advertisement allocations, and to enable advertisements to be selected for display based on the generated risk values and expected revenue values.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of an example online advertisement (“ad”) network in which an embodiment of the present invention may operate.

FIG. 2 shows a block diagram of an advertisement serving system, according to an example embodiment of the present invention.

FIG. 3 shows a block diagram of an expected revenue and risk calculator, according to an example embodiment of the present invention.

FIG. 4 shows a flowchart for an advertisement auction, according to an example embodiment of the present invention.

FIG. 5 shows a process for calculating expected revenue, according to an example embodiment of the present invention.

FIG. 6 shows a flowchart providing a process for calculating risk value, according to an example embodiment of the present invention.

FIG. 7 shows a block diagram of a risk calculator, according to an example embodiment of the present invention.

FIG. 8 shows an example covariance matrix, Σ, according to an example embodiment of the present invention.

FIG. 9 shows a block diagram of a computer that a user may use to view content and advertisements, according to an example embodiment of the present invention.

FIG. 10 shows a block diagram of a bid selector, according to an example embodiment.

FIG. 11 shows a block diagram of a bid selector system, according to an example embodiment of the present invention.

FIG. 12 shows an example plot of risk versus expected revenue, according to an embodiment of the present invention.

FIG. 13 shows a process for calculating risk value, according to an example embodiment of the present invention.

FIG. 14 shows a block diagram of a risk calculator, according to an example embodiment.

FIG. 15 shows a block diagram of an example computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. Example Operating Environment

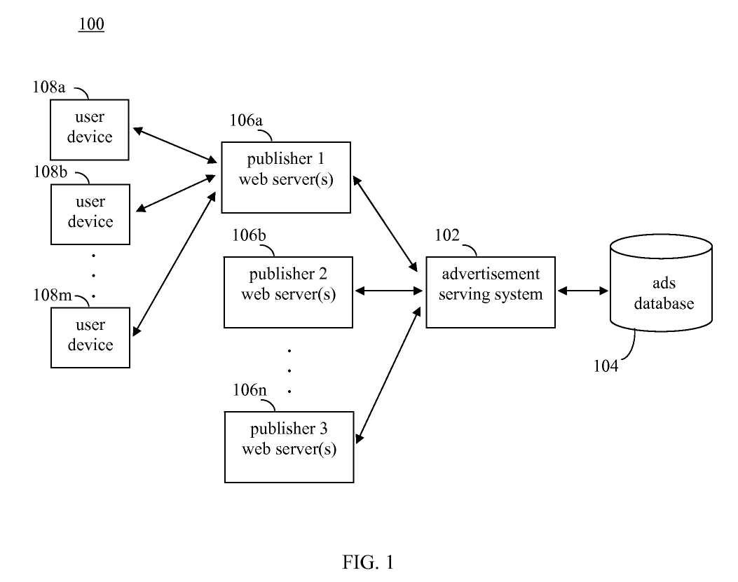

FIG. 1 is a block diagram of an example online advertisement (“ad”) network 100 in which an embodiment of the present invention may operate. Online ad network 100 operates to serve online ads provided by advertisers to websites published by publishers when such websites are accessed by certain users of the network, thereby delivering the online ads to the users. As shown in FIG. 1, online ad network 100 includes an ad serving system 102, an ads database 104, a plurality of publisher web servers 106a-106n and a plurality of user systems/devices 108a-108m.

Each of publisher web servers 106a-106n is configured to host a website published by corresponding publisher 1-n so that such website is accessible to users of network 100. A user may access such websites using a web browser or other web client installed on a system/device owned by or otherwise accessible to the user. By way of example, FIG. 1 depicts a plurality of user systems/devices 108a-108m, each of which is capable of executing a web browser that enables a user to visit any of the websites hosted by publisher web servers 106a-106n. As depicted in FIG. 1, each of client systems/devices 108a-108m is communicatively connected to publisher 1 web server(s) 106a for the purpose of accessing a website published by publisher 1; however, it is to be understood that each of user systems/devices 108a-108m can also be used to connect to any of publisher web servers 106a-106n to access the websites hosted thereon.

Persons skilled in the relevant art(s) will appreciate that user systems/devices 108a-108m may include any browser-enabled system or device, including but not limited to including a desktop computer (e.g., a personal computer, etc.), a mobile computing device (e.g., a personal digital assistant (PDA), a laptop computer, a notebook computer, etc.), a mobile email device (e.g., a RIM Blackberry® device), a telephone (e.g., a cell phone, a smart phone, etc.), or further device. In one implementation, communication between user systems/devices 108a-108m and publisher web servers 106a-106n is carried out over a local area network (LAN), a wide area network (WAN), a combination of networks, such as the Internet, etc., using well-known network communication protocols.

As further shown in FIG. 1, ad serving system 102 is communicatively connected to each of publisher web servers 106a-106n. Communication between ad serving system 102 and publisher web servers 106a-106n may also be carried out over a network, including the networks mentioned above or elsewhere herein. In one implementation, ad serving system 102 is configured to deliver online ads to each of publisher web servers 106a-106n when the websites hosted by such web servers are accessed by users, thereby facilitating the delivery of such online ads to the users. In such an implementation, each of publisher web servers 106a-106n is configured to serve the ads along with website content to the users.

In an alternative implementation, each publisher web server 106a-106n is configured to embed a request to ad serving system 102 along with the website content served to certain users. In response to the execution of the embedded request by the web browser running on the user system/device, ad serving system 102 will deliver an online ad to the user within the context of the website content. In this alternate implementation, a direct connection is established between the user system/device and ad serving system 102 (not shown in FIG. 1). This direct connection may also be established over a wide area network such as the Internet.

The online ads to be delivered to the users may be provided by one or more advertisers and stored in an ads database 104. Ads database 104 may be stored in storage system that is accessible to ad serving system 102. Although only a single ads database 104 is shown in FIG. 1, persons skilled in the relevant art(s) will appreciate that the online ads may be stored in multiple ads databases. Each online ad provided by an advertiser may be associated with a particular ad campaign sponsored by the advertiser.

Currently, performance based ads such CPC (cost per click), CPA (cost per action) are brought to a common currency of eCPM (expected cost per Mill or impression) by multiplying CPC/CPA with the chance of click/action to be comparable with CPM ads. Such existing models blindly select the ad with the highest eCPM. This is both risky and unfair because CPM ads having guaranteed payout are being compared with CPC/CPA ads having variable payout (e.g., where payment occurs only when a click/action occurs). By blindly selecting the ad having the maximum eCPM value for allocation, a risk in generating revenue is increased.

Embodiments of the present invention overcome these limitations of conventional advertisement selection techniques. In embodiments, optimization techniques are provided that allocate ads in manners that reduce risks and increase expected revenue. Example embodiments are described in the following sections.

### III. Example Embodiments

Example embodiments are described in this section for advertisement auctions. The example embodiments described herein are provided for illustrative purposes, and are not limiting. Further structural and operational embodiments, including modifications/alterations, will become apparent to persons skilled in the relevant art(s) from the teachings herein.

FIG. 2 shows a block diagram of an advertisement serving system 200, according to an example embodiment of the present invention. As shown in FIG. 2, advertisement serving system 200 includes an expected revenue and risk calculator 202. Expected revenue and risk calculator 202 is configured to determine risks and expected revenue for allocations of advertisements. Expected revenue and risk calculator 202 may be included in conventional advertisement systems, such as advertisement serving system 102 shown in FIG. 1.

As shown in FIG. 2, expected revenue and risk calculator 202 receives a plurality of bid values 204 and a plurality of conversion probabilities 206. Bid values 204 includes bids (e.g., in dollars/cents or other currency) for corresponding advertisements to be provided for display at an advertisement location (e.g., on a web page). A bid value 204 may be in terms of cost per 1000 impressions (“CPM”), cost per click (“CPC”), or cost per a pre-defined action (“CPA”) (e.g., filled out in a form). Each bid value corresponds to a particular advertisement (e.g., to an advertisement creative). Conversion probabilities 206 includes a probability of conversion corresponding to each bid/advertisement of bid values 204. An advertisement may be considered to undergo conversion upon the occurrence of numerous predetermined events, depending on the particular implementation, including the advertisement being clicked on, a product or service related to the advertisement being purchased, and/or further events. A probability of conversion (contained in conversion probabilities 206) is a probability of such a conversion event occurring for the corresponding advertisement, such that revenue in the form of the corresponding bid value is generated. Such conversion probabilities may be determined in various ways, including by monitoring a history of conversion for particular advertisements, by a prediction of the frequency of conversion for particular advertisements, and/or by any other technique.

Expected revenue and risk calculator 202 generates expected revenue values 208 and risk values 210 based on bid values 204 and conversion probabilities 206. Expected revenue values 208 includes an expected revenue value corresponding to each bid/advertisement of bid values 204, and risk values 210 includes a risk value corresponding to each expected revenue value. The risk value for a particular bid/advertisement indicates an amount of risk in generating the corresponding expected revenue value if the particular bid/advertisement is selected over the other bids/advertisements. Bid values 204 and risk values 210 may be evaluated to select an allocation of bids/advertisements having an acceptable combination of risk value and revenue value. For instance in one example, an allocation of bids/advertisements corresponding to a minimum risk value of risk values 210 may be selected. An allocation of bids/advertisements corresponding to any combination of risk value and revenue value present in bid values 204 and risk values 210 may be selected.

Note that expected revenue and risk calculator 202 may be implemented in hardware, software, firmware, or any combination thereof. For example, expected revenue and risk calculator 202 may be implemented in hardware logic, and/or may include software/firmware that executes in one or more processors of one or more computer systems, such as one or more servers. Alternatively, expected revenue and risk calculator 202 may be implemented as hardware logic/electrical circuitry.

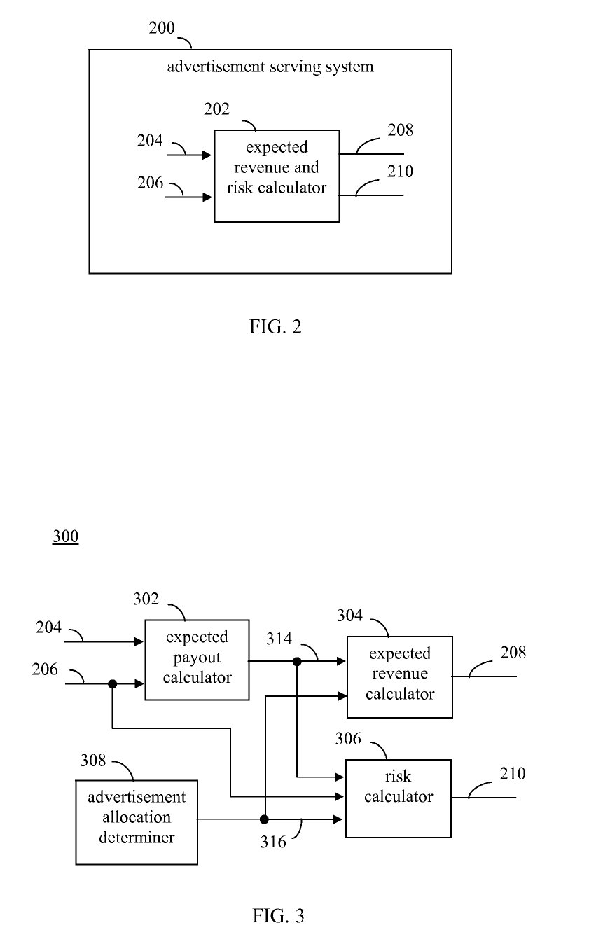

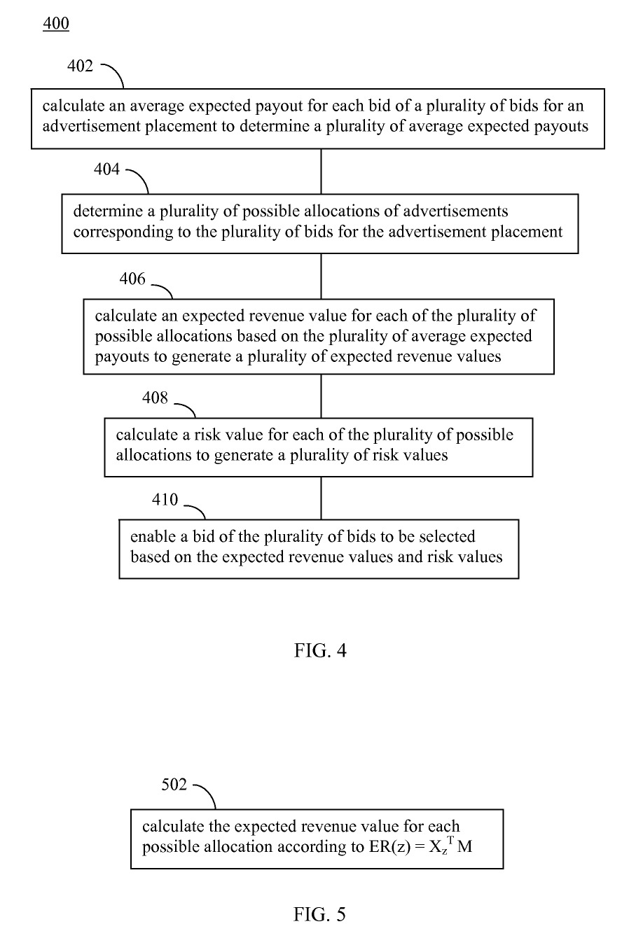

Expected revenue and risk calculator 202 may be configured in various ways to perform its functions. For instance, FIG. 3 shows a block diagram of an expected revenue and risk calculator 300, according to an example embodiment. Expected revenue and risk calculator 300 is an example of expected revenue and risk calculator 202 shown in FIG. 2. As shown in FIG. 3, expected revenue and risk calculator 300 includes an expected payout calculator 302, an expected revenue calculator 304, a risk calculator 306, and an advertisement allocation determiner 308. For illustrative purposes, expected revenue and risk calculator 300 of FIG. 3 is described with respect to FIG. 4. FIG. 4 shows a flowchart 400 for an advertisement auction, according to an example embodiment. Flowchart 400 may be performed by expected revenue and risk calculator 300. Further structural and operational embodiments will be apparent to persons skilled in the relevant art(s) based on the discussion regarding flowchart 400. Note that the steps of flowchart 400 need not necessarily be performed in the order shown in FIG. 4. Expected revenue and risk calculator 300 and flowchart 400 are described as follows.

Flowchart 400 begins with step 402. In step 402, an average expected payout for each bid of a plurality of bids for an advertisement placement is calculated to determine a plurality of average expected payouts. For example, in an embodiment, expected payout calculator 302 may be configured to perform step 402. As shown in FIG. 3, expected payout calculator 302 receives bid values 204 and conversion probabilities 206. Expected payout calculator 302 may be configured to calculate an average expected payout for each bid of bid values 204 and corresponding probability of conversion of conversion probabilities 206, to generate a plurality of average expected payouts 314. In an embodiment, the average expected payout for each bid may be expressed in terms of eCPM (expected cost per mille), which is a cost per 1000 advertisement conversions. In other embodiments, the average expected payout may be expressed in other ways.

For instance, in an embodiment, expected payout calculator 302 may generate an average expected payout (in this example, in the form of eCPM) for a bid and corresponding probability of conversion by multiplying together the bid and corresponding probability of conversion, as shown as follows as Equation 1:

eCPMᵢ=bᵢ×PR(cᵢ), Equation 1

where
bᵢ=a value of bid i corresponding to advertisement Aᵢ,
PR(cᵢ)=a probability of conversion corresponding to advertisement Aᵢ, and
eCPMᵢ=the average expected payout corresponding to bid i.
   Note that advertisement Aᵢ may also be referred to herein as “advertisement i.” Advertisement Aᵢ, and further advertisements, may be included in a set of advertisements (e.g., the advertisements considered to be bidding) referred to herein as advertisement set A.

For instance, in one illustrative example, three advertisements may bid to be provided for an advertisement placement. A first bid, b₁, corresponding to the first advertisement may be for $103, and may have a corresponding conversion probability, PR(c₁), of 0.01, for an average expected payout ($103×0.01) of $1.03. A second bid, b₂, corresponding to the second advertisement may be for $51, and may have a conversion probability, PR(c₂), of 0.02, for an average expected payout ($51×0.02) of $1.02. A third bid, b₃, corresponding to the third advertisement may be for $1, and may have a conversion probability, PR(c₃), of 1, for an average expected payout ($1×1) of $1. In this example, expected payout calculator 302 may generate plurality of average expected payouts 314 to include the vector M=[$1.03 $1.02 $1] containing these calculated average expected payout values.

In step 404, a plurality of possible allocations of advertisements corresponding to the plurality of bids is determined for the advertisement placement. For example, in an embodiment, advertisement allocation determiner 308 may be configured to perform step 404. Advertisement allocation determiner 308 is configured to determine possible advertisement allocations, which are output as possible advertisement allocations 316. A generated possible advertisement allocation essentially indicates a distribution (e.g., in terms of percentage) over which the bidding advertisements may be provided for display over a sequence of display opportunities. Advertisement allocation determiner 308 may determine the possible allocations of advertisements from possible advertisement allocations that are predetermined and stored in storage. Alternatively, advertisement allocation determiner 308 may calculate possible advertisement allocations as needed.

For instance, for the current example of three advertisements bidding for an advertisement placement, possible advertisement allocations 316 may include any number of potential allocations, including an example allocation of 30:30:40, meaning that over 100 allocation opportunities for the three advertisements, the first advertisement would be provided 30 times (30%), the second advertisement would be provided 30 times (30%), and the third advertisement would be provided 40 times (40%). Further example advertisement allocations that may be included in possible advertisement allocations 316 include 25:25:50, 20:30:50, etc. Any number of possible advertisement allocations may be included in possible advertisement allocations 316.

In step 406, an expected revenue value is calculated for each of the plurality of possible allocations based on the plurality of average expected payouts to generate a plurality of expected revenue values. For example, in an embodiment, expected revenue calculator 304 may be configured to perform step 406. As shown in FIG. 3, expected revenue calculator 304 receives average expected payouts 314 and possible advertisement allocations 316. Expected revenue calculator 304 may be configured to calculate expected revenue values for each possible advertisement allocation of possible advertisement allocations 316 based on average expected payouts 314, to generate expected revenue values 208.

For instance, in an embodiment, step 406 may include a step 502 shown in FIG. 5.

In step 502, the expected revenue value, ER, is calculated for each possible allocation according to Equation 2, shown below:

ER(z)=X_{z}^{T}M, Equation 2

where
X_{z}=a vector indicating a possible allocation z of advertisements of the plurality of possible allocations,
M=a vector containing the calculated average expected payout for each bid of the plurality of bids, and
ER(z)=the expected revenue value calculated for possible allocation z.
   In an embodiment, expected revenue calculator 304 may be configured to calculate expected revenue values according to Equation 2, to generate expected revenue values 208.

For instance, continuing the current example of the three advertisements bidding for an advertisement placement, expected revenue values may be calculated according to Equation 2 for the following example possible allocation vectors of X₁=[1 0 0] (the first advertisement is allocated 100% of the time), X₂=[0 1 0] (the second advertisement is allocated 100% of the time), X₃=[0 1 0] (the third advertisement is allocated 100% of the time), X₄=[0.3 0.3 0.4] (the first, second, and third ads are allocated 30%, 30%, and 40% of the time, respectively), and X₅=[0.25 0.25 0.5] (the first, second, and third ads are allocated 25%, 25%, and 50% of the time, respectively), using the example average expected payout vector of [$1.03 $1.02 $1] (additional and/or alternative allocation vectors may be used as desired for a particular application). The calculated expected revenue values for these five possible allocation vectors are shown below in Table 1:

TABLE 1

| | possible | | |
|---|---|---|---|
| possible | allocation vector, | average expected | expected revenue |
| allocation, z | X_{z} | payout vector, M | value, ER(z) |
| 1 | [1 0 0] | [$1.03 $1.02 $1] | $1.03 |
| 2 | [0 1 0] | [$1.03 $1.02 $1] | $1.02 |
| 3 | [0 0 1] | [$1.03 $1.02 $1] | $1 |
| 4 | [0.3 0.3 0.4] | [$1.03 $1.02 $1] | $1.015 |
| 5 | [0.25 0.25 0.5] | [$1.03 $1.02 $1] | $1.0125 |

Expected revenue calculator 304 may generate the expected revenue values shown in the right-most column of Table 1, and may output these values in expected revenue values 208.

In step 408, a risk value is calculated for each of the plurality of possible allocations to generate a plurality of risk values. For example, in an embodiment, risk calculator 306 may be configured to perform step 408. As shown in FIG. 3, risk calculator 306 receives conversion probabilities 206, average expected payouts 314, and possible advertisement allocations 316. Risk calculator 306 may be configured to calculate risk values for each possible advertisement allocation of possible advertisement allocations 316 based on based on conversion probabilities 206 and average expected payouts 314, to generate risk values 210.

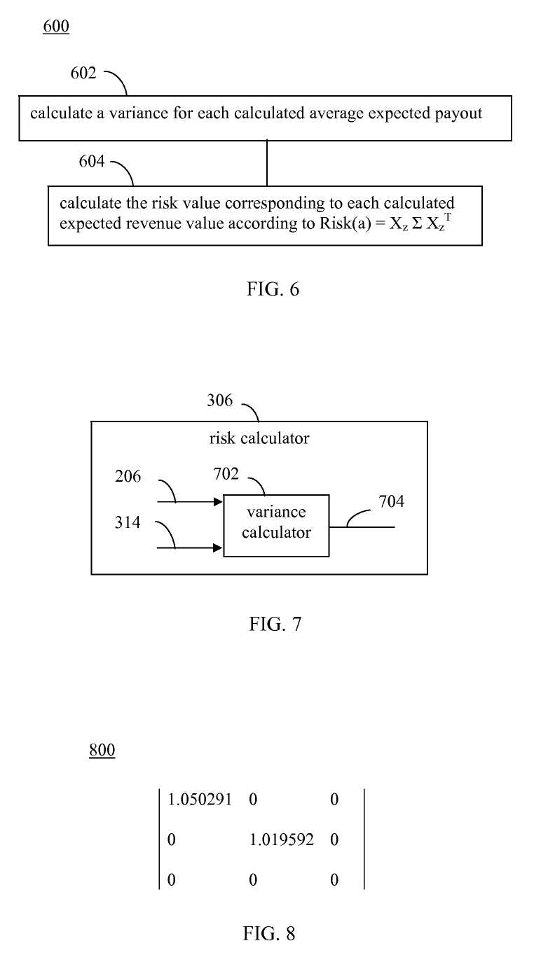

For instance, FIG. 6 shows a flowchart 600 providing a process for calculating risk value, according to an example embodiment. Flowchart 600 may be performed during step 408 of FIG. 4, for example. Flowchart 600 is described as follows.

In step 602 of flowchart 600, a variance is calculated for each calculated average expected payout. Risk calculator 306 may perform step 602, in an embodiment. For example, FIG. 7 shows a block diagram of risk calculator 306, according to an example embodiment. As shown in FIG. 6, risk calculator 306 may include a variance calculator 702. Variance calculator 702 may be configured to calculate a variance for each calculated average expected payout (e.g., that were calculated in step 402). For instance, in an embodiment, the variance, a, may calculated for each calculated average expected payout, eCPM, according to Equation 3, shown below:

σᵢ=PR(cᵢ)(eCPMᵢ−bᵢ)²+(1−PR(cᵢ))(eCPMᵢ−0)², Equation 3

where
PR(cᵢ)=a probability of conversion corresponding to bid i,
eCPMᵢ=the calculated average expected payout corresponding to bid i,
bᵢ=a value of bid i, and
σᵢ=the calculated variance corresponding to bid i.
   Equation 3 may be modified to calculate higher moments or lower partial moments (which measure the downside risk) by removing the first portion (PR(cᵢ)(eCPMᵢ−bᵢ)²), which measures payout. Equation 4 shown below is a form of Equation 3 modified in this manner, with the first portion of Equation 3 removed:

σᵢ=(1−PR(cᵢ))(eCPMᵢ)² Equation 4

Equation 4 is used to calculate a form of variance, referred to as semi-variance (SV), which measures downside variance. As shown in the embodiment of FIG. 7, variance calculator 702 receives conversion probabilities 206 and average expected payouts 314, and is configured to generate variance (e.g., semi-variance) values 704.

For instance, continuing the current example of the three advertisements bidding for an advertisement placement, semi-variance values may be calculated according to Equation 4 for each of the three bids/advertisements. The calculated semi-variance values for the current example are shown below in Table 2:

TABLE 2

| | probability of | | semi- |
|---|---|---|---|
| bid/ | conversion, | average expected | variance, |
| advertisement, i | PR(cᵢ) | payout, eCPMᵢ | σᵢ |
| 1 | 0.01 | $1.03 | 1.050291 |
| 2 | 0.02 | $1.02 | 1.019592 |
| 3 | 1 | $1 | 0 |

Variance calculator 702 may generate the semi-variance values shown in the right-most column of Table 2, and may output these values as variance values 704.

In step 604 of flowchart 600, the risk value, Risk, corresponding to each calculated expected revenue value may be calculated according to Equation 5 shown below:

Risk(a)=X_{z}ΣX_{z}^{T}, Equation 5

where
Σ=a covariance matrix containing the calculated variance for each calculated average expected payout, and
Risk(z)=the risk value calculated for possible allocation z,
   subject to
each entry of X_{z}≧0, and
X_{z}^{T}1=1 (where the “1” on the left side of the equation is a vector of 1s).
   The covariance matrix, Σ, may be formed from the semi-variance values calculated according to Equation 4. The covariance matrix has x- and y-dimensions equal to the number of bids. The calculated semi-variance values are positioned along the diagonal of the covariance matrix. In an embodiment, risk calculator 306 shown in FIG. 3 may be configured to calculate risk values according to Equation 5, to generate risk values 210.

For instance, continuing the current example of the three advertisements bidding for an advertisement placement, risk values may be calculated according to Equation 5 for each possible allocation vector shown in Table 1. In an embodiment, the covariance matrix may include the semi-variance values shown in Table 2 along its diagonal, with zeros in other locations of the covariance matrix (which assumes that risks between the advertisements are uncorrelated). FIG. 8 shows the covariance matrix, Σ, including the semi-variance values shown in Table 2 above. The calculated risk values for the current example are shown below in Table 3:

TABLE 3

| possible | possible allocation | risk value |
|---|---|---|
| allocation, z | vector, X_{z} | Risk(z) |
| 1 | [1 0 0] | 1.050291 |
| 2 | [0 1 0] | 1.019592 |
| 3 | [0 0 1] | 0 |
| 4 | [0.3 0.3 0.4] | 0.18628947 |
| 5 | [0.25 0.25 0.5] | 0.1293676875 |

The calculated risk values shown in Table 3 may be output by risk calculator 306 as risk values 210.

In step 410, a bid of the plurality of bids is enabled to be selected based on the expected revenue values and risk values. As shown in FIG. 3, expected revenue and risk calculator 202 generates expected revenue values 208 and risk values 210. A bid of bid values 204 may be selected based on expected revenue values 208 and risk values 210. The advertisement corresponding to the selected bid may be provided for display to a user. The advertisement may be displayed in a web page at one of user devices 108a-108m shown in FIG. 1 or other location that generated a corresponding advertisement request.

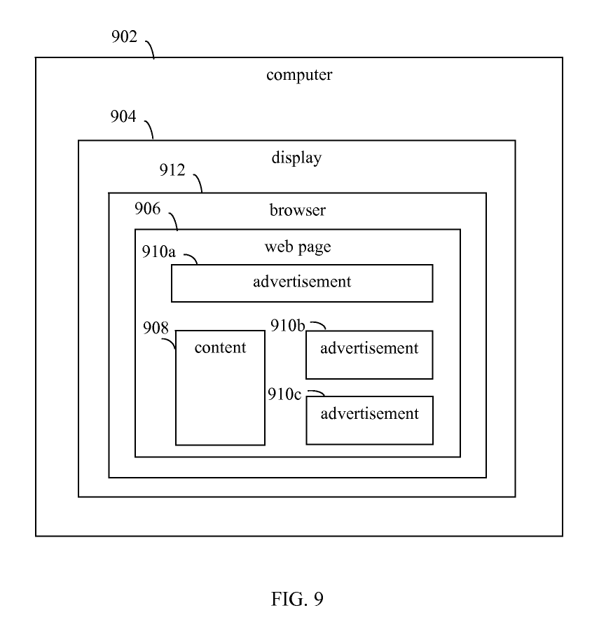

For instance, FIG. 9 shows a block diagram of a computer 902 that a user may use to view content 908. Computer 902 may be one of user devices 108a-108m shown in FIG. 1, for example. As shown in FIG. 9, computer 902 has a display 904 that displays a browser 912. Browser 912 may be any type of browser tool configured to enable browsing of web content, including Microsoft® Internet Explorer®, Mozilla® Firefox®, or any other browser tool. A web page 906 is shown open in browser 912 in FIG. 9. The user may cause web page 906 to be displayed in any manner, including navigating to web page 906 according to a URL (uniform resource locator) address for web page 906. As shown in FIG. 9, web page 906 includes content 908 that the user has caused to be displayed by navigating to web page 906. Furthermore, web page 906 may include any number and arrangement of advertisements, including advertisements 910a-910c shown in FIG. 9. Advertisements 910a-910c may be displayed according to any suitable form, including as banner ads, floating ads, pop-up ads, and video ads. In an embodiment, the advertisement corresponding to a bid selected based on expected revenue values 208 and risk values 210 may be provided to be displayed as one of advertisement 910a-910c, for example.

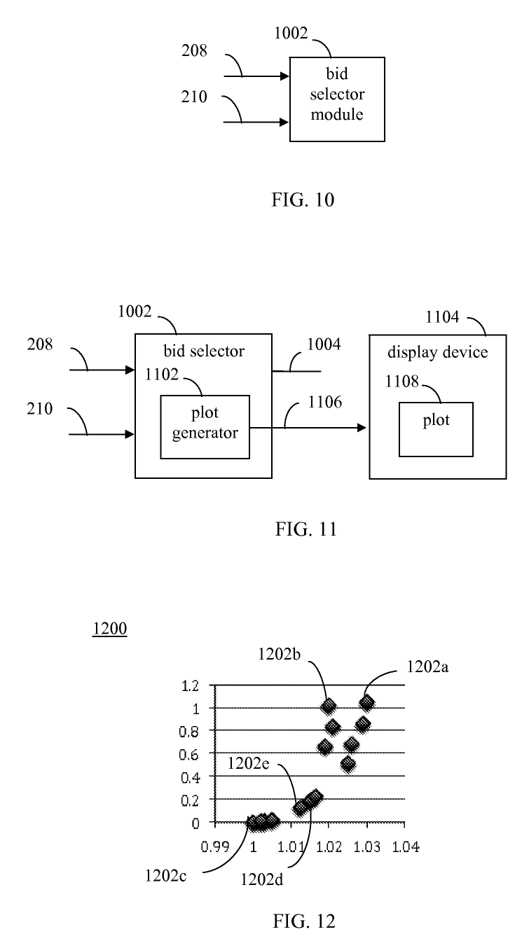

A bid of the bid values 204 may be enabled to be selected based on expected revenue values 208 and risk values 210 in any manner. For instance, FIG. 10 shows a bid selector module 1002, according to an example embodiment. Bid selector module 1002 may be included in advertisement serving system 200 shown in FIG. 2, for example. As shown in FIG. 10, bid selector module 1002 receives expected revenue values 208 and risk values 210, and generates a selected bid 1004. Bid selector module 1002 enables a risk value/expected revenue value pair to be selected from expected revenue values 208 and risk values 210. Bid selector module 1002 enables a bid of the plurality of bids to be selected based on the possible advertisement allocation corresponding to the selected risk value/expected revenue value pair.

For example, bid selector module 1002 may be configured to enable a risk value/expected revenue value pair to be selected in any manner, including manually (e.g., by a person) or automatically (e.g., by a selection algorithm). For instance, in an embodiment, bid selector module 1002 may select the risk value/expected revenue value pair that includes the lowest (minimum) risk value included in risk values 210. In another embodiment, bid selector module 1002 may select a risk value/expected revenue value pair by forming a subset of risk value/expected revenue value pairs having calculated revenue values greater than a predetermined minimum acceptable revenue value, and selecting the risk value/expected revenue value pair having the lowest risk value from the subset of risk value/expected revenue value pairs.

In another embodiment, as shown in FIG. 11, bid selector module 1002 may include a plot generator 1102. Plot generator 1102 may be configured to generate image data 1106 that is used by a display device 1104 to generate a display of a plot 1108 of risk values 208 versus expected revenue values 210. Display device 1104 may include any suitable type of display, such as a cathode ray tube (CRT) display, a liquid crystal display (LCD) display, a light emitting diode (LED) display, a plasma display, or other display type. A user may view plot 1108 to be enabled to weigh risk values versus revenue values to select a risk value/expected revenue value pair having a desired or acceptable combination of risk versus expected revenue.

In embodiments, parties involved in an advertisement exchange that conducts an advertisement auction according to the embodiments described herein may be enabled to express and/or control their associated risk. For instance, in an embodiment, a publisher that participates in an advertisement exchange may be enabled to express an acceptable risk value for an expected revenue value. The publisher may be enabled to provide acceptable risk levels for one or more values of expected revenue. In another embodiment, an advertiser that participates in an advertisement exchange may be enabled to express an acceptable risk value for an expected return in investment. In still another embodiment, the advertisement exchange may be enabled to control an overall risk in the advertisement exchange based on the expected revenue values and risk values. For example, the advertisement exchange may base an overall risk on a combination of calculated risk values (e.g., an average risk value, etc.), and may disable particular risk value/expected revenue value pairs from being selected to control overall risk.

For instance, FIG. 12 shows a plot 1200 which may be generated by plot generator 1102 and displayed by display device 1104, according to an embodiment. Plot 1200 is an example of plot 1108 shown in FIG. 11. As shown in FIG. 12, plot 1200 has an x-axis that indicates calculated expected revenue, and a y-axis that indicates calculated risk. Plot points may be plotted in plot 1200 that each correspond to a respective possible allocation of the advertisements. A plurality of plot points are shown plotted in plot 1200, including first-fifth plot points 1202a-1202e. Plot points 1202a-1202e correspond to possible allocations 1-5 shown in Tables 1 and 3. Plot points 1202a-1202e respectively are plotted according to expected revenue value and risk value coordinates of ($1.03, 1.050291), ($1.02, 1.019592), ($1, 0), ($1.015, 0.18628947), and ($1.0125, 0.1293676875). A user may view plot 1200 to select a risk value/expected revenue value pair having a particular risk value/expected revenue value.

After having selected a particular risk value/expected revenue value pair, an advertisement may be selected to be provided for display based on the advertisement allocation corresponding to the selected risk value/expected revenue value pair. In other words, bid selector module 1002 may be configured to select the bid (of bid values 204) and corresponding advertisement from the bidders according to the corresponding advertisement allocation vector. For example, in an embodiment, the advertisement of the advertisement allocation vector corresponding to the selected risk value/expected revenue value pair having the highest allocation percentage in the vector may be selected. For example, if the selected risk value/expected revenue value pair is ($1.02, 1.019592), which has a corresponding advertisement allocation vector of [0 1 0], the second advertisement may be selected because it has the highest allocation value (100%) in the allocation vector. In another embodiment, an advertisement may be selected according to the distribution indicated by the advertisement allocation. For example, an algorithm that models a “multi-faced die” having faces that each represent an advertisement, and that are biased according to the fractional allocation associated with the advertisements, may be used to select an advertisement.

For instance, in the example of FIG. 12, the user viewing plot 1200 may select plot point 1202c ($1, 0) (e.g., because it has the lowest risk value (0) while having an expected revenue value ($1) that is very close to the revenue values of the other plot points in plot 1200). If plot point 1202c ($1, 0) is selected, an advertisement may be provided for display based on the advertisement allocation vector of [0, 0, 1] corresponding to plot point 1202c. Because the advertisement allocation vector corresponding to plot point 1202c indicates that the third advertisement is provided 100% of the time (the second and third advertisements have 0% chance), the third bid may be selected, and the third advertisement may be provided to fulfill an advertisement request.

In another example, if the user selects plot point 1202d ($1.015, 0.18628947), an advertisement may be provided for display based on the advertisement allocation vector of [0.3 0.3 0.4] corresponding to plot point 1202d. This advertisement allocation vector indicates that the first advertisement is provided 30% of the time, the second advertisement is provided 30% of the time, and the third advertisement is provided 40% of the time. In such case, one of the first-third advertisements may be selected for display according to an algorithm that models a distribution of a 30% chance of the first advertisement being selected, a 30% chance of the second advertisement being selected, and a 40% chance of the third advertisement being selected. Likewise, if plot point 1202e is selected, because plot point 1202e has a corresponding advertisement allocation vector of [0.25 0.25 0.5], one of the first-third advertisements may be selected for display according to the distribution of a 25% chance of the first advertisement being selected, a 25% chance of the second advertisement being selected, and a 50% chance of the third advertisement being selected.

Note that expected payout calculator 302, expected revenue calculator 304, risk calculator 306, advertisement allocation determiner 308, variance calculator 702, bid selector module 1002, and plot generator 1102 may be implemented in hardware, software, firmware, or any combination thereof. For example, expected payout calculator 302, expected revenue calculator 304, risk calculator 306, advertisement allocation determiner 308, variance calculator 702, bid selector module 1002, and/or plot generator 1102 may be implemented in hardware logic, and/or may include software/firmware that executes in one or more processors of one or more computer systems, such as one or more servers. Alternatively, expected payout calculator 302, expected revenue calculator 304, risk calculator 306, advertisement allocation determiner 308, variance calculator 702, bid selector module 1002, and/or plot generator 1102 may be implemented as hardware logic/electrical circuitry.

A. Example Static Allocation Embodiments

A relatively simple way of generating the covariance matrix, Σ, is described above, where the diagonal of the covariance matrix is filled according to Equation 4, and the remainder of the covariance matrix is filled with zeros. However, such an embodiment assumes that risks between the advertisements are uncorrelated. In another embodiment, risks between advertisements may not be assumed to be uncorrelated. The correlated risks between advertisements may be considered. For example, having a mixture of only CPA (cost per action) advertisements may be more risky than having a blend of CPA, CPC (cost per click), and CPM (cost per mille) advertisements. Furthermore, choosing advertisements always from the same campaign or advertiser may be risky, and is not fair to other advertisers. In this subsection, embodiments are provided that measure the covariance between advertisements, and that do not assume that the performance of advertisements is independent.

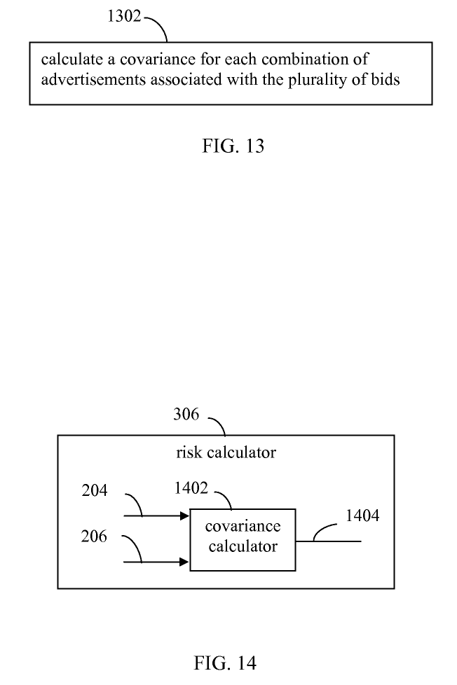

For instance, FIG. 13 shows a step 1302 providing a process for calculating risk value, according to an example embodiment. Step 1302 may be performed during step 408 of FIG. 4, for example. In step 1302, a covariance is calculated for each calculated average expected payout. Risk calculator 306 shown in FIG. 3 may perform step 1302, in an embodiment. For example, FIG. 14 shows a block diagram of risk calculator 306, according to an example embodiment. As shown in FIG. 14, risk calculator 306 may include a covariance calculator 1402. Covariance calculator 1402 may be configured to calculate a covariance for each combination of advertisements associated with bid values 204. As shown in the embodiment of FIG. 14, covariance calculator 1402 receives bid values 204 and conversion probabilities 206, and is configured to generate variance (e.g., covariance) values 1404.

For instance, in an embodiment, the covariance, σ_{i,j}, may calculated by covariance calculator 1402 for each combination of advertisements, according to Equation 6, shown below:

$${σ}_{i , j} = {\sum }_{n ∈ {P}_{Tree}} PR ( n \vert i , j ) ( \begin{matrix}( 1 - PR ( {c}_{i} \vert n ) ) \\ ( PR ( {c}_{i} \vert n ) {b}_{i} )\end{matrix} ) ( \begin{matrix}( 1 - PR ( {c}_{j} \vert n ) ) \\ ( PR ( {c}_{j} \vert n ) {b}_{j} )\end{matrix} ) \\ where \\ {\sum }_{n ∈ {P}_{Tree}} PR ( n \vert i , j ) = 1 , \qquad Equation 6$$

n=a subset of impressions that is common to both bids i and j;
bᵢ=a value of bid i corresponding to an advertisement Aᵢ;
bⱼ=a value of bid j corresponding to an advertisement Aⱼ;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σ_{i,j}=the calculated covariance corresponding to bids i and j;
   wherein the covariance matrix contains the calculated variance for each combination of bids of the plurality of bids.

The calculated covariance values may be used to fill the non-diagonal positions in the covariance matrix, Σ, that were previously filled with zeros, to represent the covariance between corresponding advertisements.

As stated above, n is a subset of impressions which may also be arranged into a tree of subsets of impressions—a “Predict Tree.” This subset of impressions can also be referred to as a node n in the predict tree. PR(n|i, j) is used to identify nodes which are common to both of advertisements i and j. This probability indicates a support/confidence of the prediction. Equation 6 measures the downside risk (similar to Equation 4 above), and thus considers the case where advertisements i and j both fail to undergo a conversion event. Furthermore, the covariance of advertisements that belong to the same sub-tree of the predict tree tends to be higher, such as those belonging to the same campaign/advertiser. For many internal targeting nodes, PR(cᵢ|n) is same as PR(cⱼ|n), causing Equation 6 to become similar to Equation 3. The technique of Equation 6 for computing the covariance can be viewed as breaking an opportunity set into smaller subsets, with each subset identified by the attributes of the opportunities in the subset. A subset is also associated with a node in the predict tree (e.g., not limited to any predict tree based model). The disjoint opportunity subsets may be viewed, a variance of advertisements in each subset may be observed, and an overall covariance may be calculated according to Equation 6. Nodes that are common ancestors of advertisements i and j are chosen, and PR(n|i, j) may be calculated according to Equation 7:

PR(n|i, j)=|unique(n)|/|rootᵢⱼ| Equation 7

where

unique(n)=the unique impressions covered by n that are not covered by the children of n, and

rootᵢⱼ=the root of the ancestors of advertisements Aᵢ and Aⱼ.

According to Equation 6, the covariance is estimated, and an allocation (e.g., an allocation of minimal risk and maximal revenue) across all advertisements in the system may be calculated, irrespective of targeting. A static allocation fraction and a rank is determined for each advertisement. As this is a static allocation, budget may play a role. As a result, the following budget constraint (Equation 8) may be added to the constraints associated with Equation 5 above:

XᵢM≦DᵢE, Equation 8

where
D=a normalization budget vector representing a normalized budget of all of the bidding advertisements, where |D|=1.
   In such an embodiment, the expected revenue E is known from previously being calculated. Expected revenue can be increased, and the variance can be observed. An advertisement allocation may be sought that still keeps variance relatively low. M can be computed as done previously, but is weighed by PR(n|i).

At the time an advertisement is requested, an estimate of the probability of conversion is received for each bid/advertisement pair. Expected revenue and risk calculator 202 determines advertisement allocations for the advertisements participating in the auction. As described above, an algorithm modeling a biased multi-face coin may be used to select a winning bid/advertisement.

In some situations, the order of allocation rank may be maintained in a subset. If advertisements do not share targeting attributes, then the covariance will be 0 and will not affect the optimal allocation. Hence, selecting advertisements for given targeting attributes and normalizing may provide a fractional allocation for that set of attributes. Some advantages for this situation include:

1. Such a static allocation helps index and serve advertisements better, as the importance of each advertisement is known beforehand.

2. Such a static allocation may be used along with network reachability to index the advertisements.

Some disadvantages include:

1. Allocation is static and does not reflect dynamic changes such as change in bid, new advertisements, etc.

2. If the allocation is 0 for particular advertisements, smoothing may be desired.

3. Specific performance is not taken into account. For example, an advertisement may perform badly overall, but may perform extremely well for a particular targeting attribute. Static allocation does not account for this. This may be overcome by finding static allocation across different nodes of the predict tree.

B. Further Example Static Allocation Embodiments

In embodiments, at least some of the disadvantages described in the previous subsection may be overcome using a more complicated optimization problem, where allocation of advertisements across nodes of the predict tree is tracked.

For instance, the predict tree may be used to estimate covariance (again semi-variance) using Equation 9. For every node n in the predict tree, covariance may be calculated according to Equation 9 (e.g., during step 1302 of FIG. 13), as follows:

σᵢⱼₙ=((1−PR(cᵢ|n))(PR(c_{i|n})bᵢ))((1−PR(cⱼ|n))(PR(cⱼ|n)bⱼ)) Equation 9

where
σijn=a three-dimensional covariance between a node n, an advertisement Aᵢ, and an advertisement Aⱼ.

For example, in an embodiment, covariance calculator 1402 shown in FIG. 14 may be configured to calculate covariance according to Equation 9. In Equation 9, nodes n that are common to both advertisements i and j are considered. In Equation 9, downside risk is being measured, and hence the situation where both of advertisements i and j fail to undergo conversion is being considered.

For each of the nodes in the predict tree, variance may be calculated based on the estimate for probability of conversion at that node. Because this probability of conversion is the same for all advertisements for internal nodes, Equation 8 is the same as Equation 6 for most cases. For example, for a node that identifies a campaign id, all the advertisements that belong to the campaign id will have the same pair-wise covariance, because the probability of conversion is the same. For advertisements that do not belong to this campaign, the pair-wise covariance with any other advertisement for the node is 0. A 3-dimensional covariance matrix is generated, between all the advertisements and across all nodes in the predict tree. A entry in this covariance matrix as σᵢⱼₙ.

In this setting, covariance may be estimated using Equation 9 for all pairs of advertisements over all the nodes in the predict tree, to determine an advertisement allocation (e.g., having minimal risk and maximal revenue) across all advertisements in the system across all targeting attributes/nodes. For example, a Quadratic Programming technique, a linear programming technique, or other suitable technique may be used. An example suitable quadratic programming technique is described in Y. Kroll, H. Levy, and H. Markowitz, “Mean-Variance Versus Direct Utility Maximization”, The Journal of Finance, Vol. 39, No. 1 (March, 1984), pp. 47-61, which is incorporated by reference herein in its entirety. An example suitable linear programming technique is described in H. Kono and H. Yamazaki, “Mean-Absolute Deviation Portfolio Optimization Model and Its Applications to Tokyo Stock Market”, Management Sciences, 39, (1992), pp. 519-531, which is incorporated by reference herein in its entirety. A two-dimensional static allocation matrix−Xᵢₙ is generated that represents the fraction of allocation of advertisement i to the opportunity represented by node n. As this is a static allocation, budget may play a role. As a result, the problem may be modified to an optimal ad allocation problem with budget, posed as an optimization problem, as indicated by Equation 10 as follows:

$$minimize {\sum }_{n ∈ {P}_{Tree}} PR ( n ) {\sum }_{i ∈ A} {X}_{i n} {\sum }_{j ∈ A} {X}_{jn} {σ}_{jin} ( variance )$$

$$subject to$$

$${X}_{i n} \geq 0 , \\ {\sum }_{n ∈ {P}_{Tree}} PR ( n ) {\sum }_{i ∈ A} {X}_{i n} {P}_{i n} {b}_{i} = E , \\ {\sum }_{n ∈ {P}_{Tree}} {\sum }_{i ∈ A} {X}_{i n} = 1 , and$$

$${\sum }_{n ∈ {P}_{Tree}} {X}_{i n} {P}_{i n} {b}_{i} = {D}_{i} E ( budget constraint ) .$$

where
Pᵢₙ=a conversion probability for advertisement Aᵢ in the nth node.
   Although Equation 10 is complex, it provides a fine grained static allocation of advertisements across various nodes of the predict tree.

Note that covariance calculator 1402 may be implemented in hardware, software, firmware, or any combination thereof. For example, covariance calculator 1402 may be implemented in hardware logic, and/or may include software/firmware that executes in one or more processors of one or more computer systems, such as one or more servers. Alternatively, covariance calculator 1402 may be implemented as hardware logic/electrical circuitry.

### IV. Example Computer Implementation

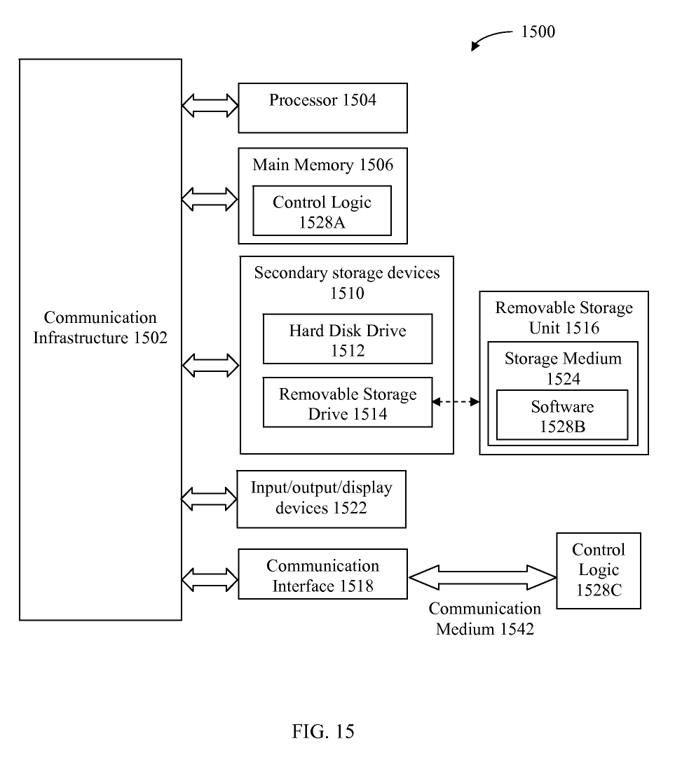

The embodiments described herein, including systems, methods/processes, and/or apparatuses, may be implemented using well known servers/computers, such as a computer 1500 shown in FIG. 15. For example, advertisement serving system 200 (FIG. 2), expected revenue and risk calculator 202 (FIG. 2), expected revenue and risk calculator 300 (FIG. 3), and flowchart 400 shown in FIG. 4 can be implemented using one or more computers 1500.

Computer 1500 can be any commercially available and well known computer capable of performing the functions described herein, such as computers available from International Business Machines, Apple, Sun, HP, Dell, Cray, etc. Computer 1500 may be any type of computer, including a desktop computer, a server, etc.

Computer 1500 includes one or more processors (also called central processing units, or CPUs), such as a processor 1504. Processor 1504 is connected to a communication infrastructure 1502, such as a communication bus. In some embodiments, processor 1504 can simultaneously operate multiple computing threads.

Computer 1500 also includes a primary or main memory 1506, such as random access memory (RAM). Main memory 1506 has stored therein control logic 1528A (computer software), and data.

Computer 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, computer 1500 may include an industry standard interface, such a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer useable or readable storage medium 1524 having stored therein computer software 1528B (control logic) and/or data. Removable storage unit 1516 represents a floppy disk, magnetic tape, compact disk, DVD, optical storage disk, or any other computer data storage device. Removable storage drive 1514 reads from and/or writes to removable storage unit 1516 in a well known manner.

Computer 1500 also includes input/output/display devices 1522, such as monitors/displays, keyboards, pointing devices, etc.

Computer 1500 further includes a communication or network interface 1518. Communication interface 1518 enables the computer 1500 to communicate with remote devices. For example, communication interface 1518 allows computer 1500 to communicate over communication networks or mediums 1542 (representing a form of a computer useable or readable medium), such as LANs, WANs, the Internet, etc. Network interface 1518 may interface with remote sites or networks via wired or wireless connections.

Control logic 1528C may be transmitted to and from computer 1500 via the communication medium 1542.

Any apparatus or manufacture comprising a computer useable or readable medium having control logic (software) stored therein is referred to herein as a computer program product or program storage device. This includes, but is not limited to, computer 1500, main memory 1506, secondary storage devices 1510, and removable storage unit 1516. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing advertisement serving system 200, expected revenue and risk calculator 202, expected revenue and risk calculator 300, expected payout calculator 302 (FIG. 3), expected revenue calculator 304 (FIG. 3), risk calculator 306 (FIG. 3), advertisement allocation determiner 308 (FIG. 3), variance calculator 702 (FIG. 7), bid selector module 1002 (FIGS. 10 and 11), plot generator 1102 (FIG. 11), covariance calculator 1402 (FIG. 14), flowchart 400, step 502 (FIG. 5), flowchart 600 (FIG. 6), step 1302 (FIG. 13) and/or further embodiments of the present invention described herein (including any one or more steps of flowcharts 400 and 600). Embodiments of the invention are directed to computer program products comprising such logic (e.g., in the form of program code or software) stored on any computer useable medium. Such program code, when executed in a processing unit (that includes one or more data processing devices), causes a device to operate as described herein.

The invention can work with software, hardware, and/or operating system implementations other than those described herein. Any software, hardware, and operating system implementations suitable for performing the functions described herein can be used.

### V. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for an advertisement auction, comprising:
receiving a plurality of bids for an advertisement placement;
calculating an average expected payout for each bid of the plurality of bids to determine a plurality of average expected payouts;
determining a plurality of possible allocations of advertisements corresponding to the plurality of bids for the advertisement placement;
calculating an expected revenue value for each of the plurality of possible allocations based on the plurality of average expected payouts to generate a plurality of expected revenue values;
calculating a risk value for each of the plurality of possible allocations to generate a plurality of risk values; and
enabling a bid of the plurality of bids to be selected based on the expected revenue values and risk values.

2. The method of claim 1, wherein said enabling comprises:
displaying a plot of the calculated risk value versus the calculated expected revenue value.

3. The method of claim 1, wherein said enabling comprises:
enabling a risk value to be selected from the plurality of risk values; and
enabling a bid of the plurality of bids to be selected based on the possible allocation corresponding to the selected risk value.

4. The method of claim 1, wherein said calculating an expected revenue value for each of the plurality of possible allocations based on the plurality of average expected payouts to generate a plurality of expected revenue values comprises:
calculating the expected revenue value for each possible allocation according to
ER(z)=X_{z}^{T}M,
where
X_{z}=a vector indicating a possible allocation z of advertisements of the plurality of possible allocations,
M=a vector containing the calculated average expected payout for each bid of the plurality of bids, and
ER(z)=the expected revenue value calculated for possible allocation z; and
wherein said calculating a risk value for each of the plurality of possible allocations to generate a plurality of risk values comprises:
calculating a variance for each calculated average expected payout, and
calculating the risk value corresponding to each calculated expected revenue value according to
Risk(a)=X_{z}ΣX_{z}^{T},
where
Σ=a covariance matrix containing the calculated variance for each calculated average expected payout, and
Risk(z)=the risk value calculated for possible allocation z.

5. The method of claim 4, wherein said calculating a variance for each calculated average expected payout comprises:
calculating a variance for each calculated average expected payout according to
σᵢ=(1−PR(cᵢ))(eCPMᵢ)²,
where
PR(cᵢ)=a probability of conversion corresponding to bid i;
eCPMᵢ=the calculated average expected payout corresponding to bid i; and
σᵢ=the calculated variance corresponding to bid i.

6. The method of claim 4, further comprising:
calculating a covariance for each combination of advertisements associated with the plurality of bids according to
$${σ}_{i , j} = {\sum }_{n ∈ {P}_{Tree}} PR ( n \vert i , j ) ( \begin{matrix}( 1 - PR ( {c}_{i} \vert n ) ) \\ ( PR ( {c}_{i} \vert n ) {b}_{i} )\end{matrix} ) ( \begin{matrix}( 1 - PR ( {c}_{j} \vert n ) ) \\ ( PR ( {c}_{j} \vert n ) {b}_{j} )\end{matrix} )$$
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σ_{i,j}=the calculated covariance corresponding to bids i and j;
wherein the covariance matrix contains the calculated covariance for each combination of bids of the plurality of bids.

7. The method of claim 4, further comprising:
calculating a covariance for each combination of advertisements associated with the plurality of bids according to
σᵢⱼₙ=((1−PR(cᵢ|n))(PR(cᵢ|n)bᵢ))((1−PR(cⱼ|n))(PR(cⱼ|n)bⱼ))
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σᵢⱼₙ=the calculated covariance corresponding to bids i and j and the node n;
wherein the covariance matrix contains the calculated covariance for each combination of bids of the plurality of bids.

8. The method of claim 1, further comprising:
enabling a publisher to express an acceptable risk value for an expected revenue value.

9. The method of claim 1, further comprising:
enabling an advertisement exchange that conducts the advertisement auction to control an overall risk in the advertisement exchange based on the expected revenue values and risk values.

10. The method of claim 1, further comprising:
enabling an advertiser in an advertisement exchange to express an acceptable risk value for an expected return in investment.

11. An advertisement serving system, comprising:
an expected payout calculator configured to calculate an average expected payout for each bid of a plurality of bids for an advertisement placement to determine a plurality of average expected payouts;
an expected revenue calculator configured to calculate an expected revenue value for each of a plurality of possible allocations of advertisements corresponding to the plurality of bids based on the plurality of average expected payouts to generate a plurality of expected revenue values;
a risk calculator configured to calculate a risk value for each of the plurality of possible allocations to generate a plurality of risk values; and
a bid selector module configured to enable a bid of the plurality of bids to be selected based on the expected revenue values and risk values.

12. The advertisement serving system of claim 11, wherein the bid selector module includes a plot generator configured to generate image data configured to be used to generate a plot of the calculated risk value versus the calculated expected revenue value.

13. The advertisement serving system of claim 11, wherein the bid selector module is configured to enable a risk value to be selected from the plurality of risk values, and to enable a bid of the plurality of bids to be selected based on the possible allocation corresponding to the selected risk value.

14. The advertisement serving system of claim 11, wherein the expected revenue calculator is configured to calculate the expected revenue value for each possible allocation according to
ER(z)=X_{z}^{T}M,
where
X_{z}=a vector indicating a possible allocation z of advertisements of the plurality of possible allocations,
M=a vector containing the calculated average expected payout for each bid of the plurality of bids, and
ER(z)=the expected revenue value calculated for possible allocation z; and
wherein the risk calculator is configured to calculate a variance for each calculated average expected payout, and to calculate the risk value corresponding to each calculated expected revenue value according to
Risk(a)=X_{z}ΣX_{z}^{T},
where
Σ=a covariance matrix containing the calculated variance for each calculated average expected payout, and
Risk(z)=the risk value calculated for possible allocation z.

15. The advertisement serving system of claim 14, wherein the risk calculator includes:
a variance calculator configured to calculate a variance for each calculated average expected payout according to
σᵢ=(1−PR(cᵢ))(eCPMᵢ)²,
where
PR(cᵢ)=a probability of conversion corresponding to bid i;
eCPMᵢ=the calculated average expected payout corresponding to bid i; and
σᵢ=the calculated variance corresponding to bid i.

16. The advertisement serving system of claim 14, wherein the risk calculator includes:
a covariance calculator configured to calculate a covariance for each combination of advertisements associated with the plurality of bids according to
$${σ}_{i , j} = {\sum }_{n ∈ {P}_{Tree}} PR ( n \vert i , j ) ( \begin{matrix}( 1 - PR ( {c}_{i} \vert n ) ) \\ ( PR ( {c}_{i} \vert n ) {b}_{i} )\end{matrix} ) ( \begin{matrix}( 1 - PR ( {c}_{j} \vert n ) ) \\ ( PR ( {c}_{j} \vert n ) {b}_{j} )\end{matrix} )$$
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σ_{i,j}=the calculated covariance corresponding to bids i and j;
wherein the covariance matrix contains the calculated covariance for each combination of bids of the plurality of bids.

17. The advertisement serving system of claim 14, wherein the risk calculator includes:
a covariance calculator configured to calculate a covariance for each combination of advertisements associated with the plurality of bids according to
σᵢⱼₙ=((1−PR(cᵢ|n))(PR(cᵢ|n)bᵢ))((1−PR(cⱼ|n))(PR(cⱼ|n)bⱼ))
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σᵢⱼₙ=the calculated covariance corresponding to bids i and j and the subset of impressions n;
wherein the covariance matrix contains the calculated covariance for each combination of bids of the plurality of bids.

18. A computer program product comprising a computer-readable medium having computer program logic recorded thereon for enabling a processor to select advertisements, comprising:
first computer program logic means for enabling the processor to calculate an average expected payout for each bid of a plurality of bids for an advertisement placement to determine a plurality of average expected payouts;
second computer program logic means for enabling the processor to calculate an expected revenue value for each of a plurality of possible allocations of advertisements corresponding to the plurality of bids based on the plurality of average expected payouts to generate a plurality of expected revenue values;
third computer program logic means for enabling the processor to calculate a risk value for each of the plurality of possible allocations to generate a plurality of risk values; and
fourth computer program logic means for enabling the processor to enable a bid of the plurality of bids to be selected based on the expected revenue values and risk values.

19. The computer program product of claim 18, wherein the fourth computer program logic means includes:
fifth computer program logic means for enabling the processor to generate image data configured to be used to generate a plot of the calculated risk value versus the calculated expected revenue value.

20. The computer program product of claim 18, wherein the fourth computer program logic means includes:
fifth computer program logic means for enabling the processor to enable a risk value to be selected from the plurality of risk values; and
sixth computer program logic means for enabling the processor to enable a bid of the plurality of bids to be selected based on the possible allocation corresponding to the selected risk value.

21. The computer program product of claim 18, wherein the second computer program logic means includes fifth computer program logic means for enabling the processor to calculate the expected revenue value for each possible allocation according to
ER(z)=X_{z}^{T}M,
where
X_{z}=a vector indicating a possible allocation z of advertisements of the plurality of possible allocations,
M=a vector containing the calculated average expected payout for each bid of the plurality of bids, and
ER(z)=the expected revenue value calculated for possible allocation z; and
wherein the third computer program logic means includes sixth computer program logic means for enabling the processor to calculate a variance for each calculated average expected payout, and to calculate the risk value corresponding to each calculated expected revenue value according to
Risk(a)=X_{z}ΣX_{z}^{T},
where
Σ=a covariance matrix containing the calculated variance for each calculated average expected payout, and
Risk(z)=the risk value calculated for possible allocation z.

22. The computer program product of claim 21, wherein the third computer program logic means includes seventh computer program logic means for enabling the processor to calculate a variance for each calculated average expected payout according to
σᵢ=(1−PR(cᵢ))(eCPMᵢ)²,
where
PR(cᵢ)=a probability of conversion corresponding to bid i;
eCPMᵢ=the calculated average expected payout corresponding to bid i; and
σᵢ=the calculated variance corresponding to bid i.

23. The computer program product of claim 21, wherein the third computer program logic means includes seventh computer program logic means for enabling the processor to calculate a covariance for each combination of advertisements associated with the plurality of bids according to
$${σ}_{i , j} = {\sum }_{n ∈ {P}_{Tree}} PR ( n \vert i , j ) ( \begin{matrix}( 1 - PR ( {c}_{i} \vert n ) ) \\ ( PR ( {c}_{i} \vert n ) {b}_{i} )\end{matrix} ) ( \begin{matrix}( 1 - PR ( {c}_{j} \vert n ) ) \\ ( PR ( {c}_{j} \vert n ) {b}_{j} )\end{matrix} )$$
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σ_{i,j}=the calculated covariance corresponding to bids i and j;
wherein the covariance matrix contains the calculated covariance for each combination of bids of the plurality of bids.
24. The computer program product of claim 21, wherein the third computer program logic means includes seventh computer program logic means for enabling the processor to calculate a covariance for each combination of advertisements associated with the plurality of bids according to
σᵢⱼₙ=((1−PR(cᵢ|n))(PR(cᵢ|n)bᵢ))((1−PR(cⱼ|n))(PR(cⱼ|n)bⱼ))
where
n=a subset of impressions that is common to both bids i and j;
bᵢ=a value of bid i;
bⱼ=a value of bid j;
PR(n|i, j)=a probability of conversion corresponding to bids i and j for the subset of impressions n;
PR(cᵢ|n)=a probability of conversion corresponding to bid i for the subset of impressions n;
PR(cⱼ|n)=a probability of conversion corresponding to bid j for the subset of impressions n; and
σᵢⱼₙ=the calculated covariance corresponding to bids i and j and the subset of impressions n;
wherein the covariance matrix contains the calculated covariance for each combination of bids of the plurality of bids.
